(19) United States
(12) Patent Application Publication
(10) Pub. No.: US 2010/0122655 A1
(43) Pub. Date: May 20, 2010

(54) BALL SUPPORTED SHADOW FRAME

(76) Inventors: Robin L. Tiner, (US); John M. White, (US); Kyung-Tae Kim, (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/614,479

(22) Filed: Nov. 9, 2009

Related U.S. Application Data
(60) Provisional application No. 61/114,866, filed on Nov. 14, 2008.

(51) Int. Cl. B05C 11/00; B23P 11/00

(52) U.S. Cl. 118/504; 29/464

(57) ABSTRACT

Embodiments disclosed herein generally include an alignment assembly for aligning a shadow frame on a susceptor. For producing large area flat panel displays or solar panels, the shadow frame that protects the areas of the susceptor not covered by the substrate from deposition may be so large that the shadow frame bends and doesn't properly align. By utilizing an alignment assembly having one or more ball bearings, the shadow frame may roll on the susceptor to a proper alignment position. Thus, the shadow frame may be prevented from bending and also align on the susceptor.

### CROSS-REFERENCE TO RELATED APPLICATIONS

This application claims benefit of U.S. Provisional Patent Application Ser. No. 61/114,866 (APPM/13876L), filed Nov. 14, 2008, which is herein incorporated by reference.

### BACKGROUND OF THE INVENTION

1. Field of the Invention

Embodiments of the present invention generally relate to an alignment assembly for a shadow frame.

2. Description of the Related Art

When depositing material onto a substrate during processing, material may deposit onto other areas of the processing chamber as well. If the substrate is not as large as the susceptor, then material may deposit onto the susceptor upon which the substrate may be situated during processing. Material deposited onto the susceptor may be problematic because the material may flake off during susceptor movement and/or substrate movement. The material that flakes off may contaminate the substrate or substrates later processed in the same processing chamber.

Additionally, material deposited on the substrate may bridge to material deposited on the susceptor. When the substrate is removed, the bridged material may break and potentially damage the substrate and/or the material deposited on the substrate.

When material is deposited onto the susceptor, the susceptor surface that receives the substrate may not be substantially planar and thus, substrates that are placed on the susceptor may not be properly aligned. The substrate could break. The material buildup on the susceptor could also lead to uneven deposition on the substrate. Because the substrate may not be resting on a planar surface, the substrate may bend and thus, the deposition surface of the substrate may not be substantially planar which may lead to uneven deposition.

Therefore, there is a need in the art to prevent or reduce deposition from occurring on a susceptor not covered by a substrate during processing.

### SUMMARY OF THE INVENTION

Embodiments disclosed herein generally include an alignment assembly for aligning a shadow frame on a susceptor. For producing large area flat panel displays or solar panels, the shadow frame that protects the areas of the susceptor not covered by the substrate from deposition may be so large that the shadow frame bends and doesn't properly align. By utilizing an alignment assembly having one or more ball bearings, the shadow frame may roll on the susceptor to a proper alignment position. Thus, the shadow frame may be prevented from bending and also align on the susceptor.

In one embodiment, a shadow frame is disclosed. The shadow frame includes a shadow frame body and one or more shadow frame slider assemblies recessed into the shadow frame body.

In another embodiment, an apparatus is disclosed. The apparatus includes a processing chamber body and a susceptor disposed in the processing chamber body and having a surface for receiving a substrate. The susceptor is movable from a first position to a second position. The apparatus also includes one or more slider elements coupled to the susceptor and a shadow frame disposed in the processing chamber body. The shadow frame is movable from a third position spaced from the susceptor to a fourth position in contact with the susceptor. The apparatus also includes one or more shadow frame slider assemblies coupled to the shadow frame.

In another embodiment, a method of aligning a shadow frame above a susceptor is disclosed. The method includes moving a susceptor from a first position to a second position. The susceptor has one or more slider surfaces. The method also includes moving a shadow frame from a third position spaced from the susceptor and a fourth position in contact with the susceptor when the susceptor is in the second position. The shadow frame has one or more shadow frame slider assemblies coupled thereto. The method also includes sliding the one or more shadow frame slider assemblies along the one or more slider surfaces to align the shadow frame above the susceptor.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic cross sectional view of an apparatus according to one embodiment of the invention.

FIG. 2A is a schematic top view of a shadow frame.

FIG. 2B is a schematic cross sectional view of a misaligned shadow frame.

FIG. 2C is a schematic cross sectional view of a shadow frame aligned with an alignment assembly according to one embodiment.

FIG. 2D is a schematic cross sectional view of an alignment pin assembly according to one embodiment.

FIG. 3A is a schematic cross sectional view of an alignment ball assembly in a raised position according to one embodiment.

FIG. 3B is a schematic cross sectional view of the alignment ball assembly of FIG. 3A in a lowered position.

FIG. 3C is a schematic cross sectional view of an alignment ball assembly embedded according to another embodiment.

FIG. 3D is a schematic cross sectional view of the alignment ball assembly of FIG. 3C in an aligned position.

FIG. 4A is a schematic cross sectional view of an apparatus 400 according to one embodiment.

FIG. 4B is a schematic bottom view of the shadow frame 402 of FIG. 4A.

FIG. 5 is a schematic cross sectional view of an apparatus 500 according to another embodiment.

FIG. 6A is a schematic cross sectional view of an alignment assembly according to another embodiment.

FIG. 6B is an isometric view of the alignment receiver of FIG. 6A.

FIG. 6C is an isometric view of the alignment button of FIG. 6A.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments disclosed herein generally include an alignment assembly for aligning a shadow frame on a susceptor. For producing large area flat panel displays or solar panels, the shadow frame that protects the areas of the susceptor not covered by the substrate from deposition may be so large that the shadow frame bends and doesn't properly align. By utilizing an alignment assembly having one or more ball bearings, the shadow frame may roll on the susceptor to a proper alignment position. Thus, the shadow frame may be prevented from bending and also align on the susceptor.

The invention, as described below, may be practiced in a plasma enhanced chemical vapor deposition (PECVD) system available from AKT America, Inc., a subsidiary of Applied Materials, Inc., Santa Clara, Calif. It is contemplated that the invention may be practiced in other plasma processing chambers, including those from other manufacturers.

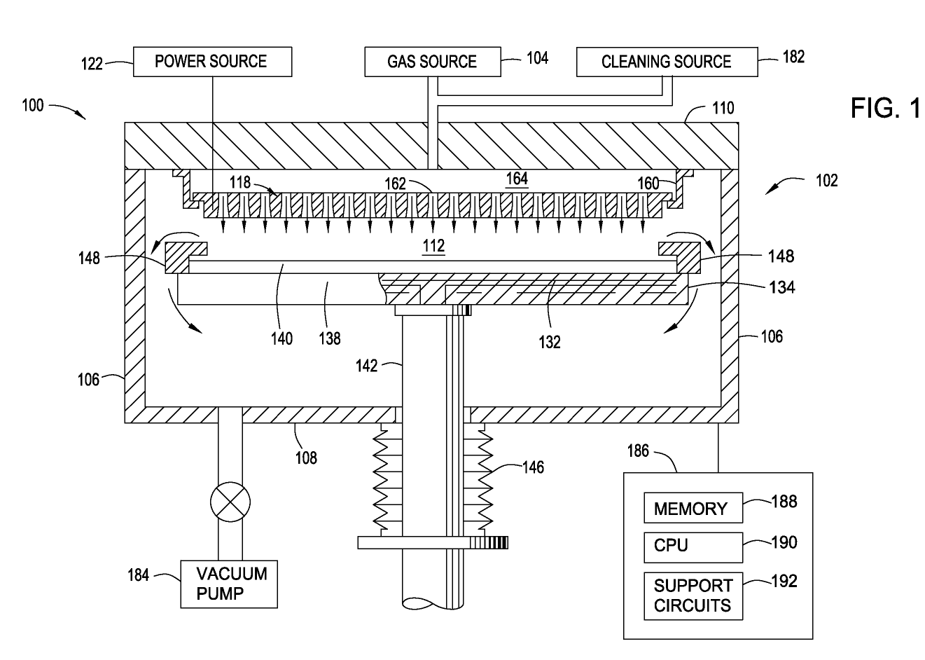

FIG. 1 is a schematic cross-sectional view of one embodiment of an apparatus 100 according to one embodiment. The apparatus 100 may include a processing chamber 102 coupled to a gas source 104. The processing chamber 102 has walls 106 and a bottom 108 that partially define a process volume 112. The process volume 112 may be accessed through a slit valve opening (not shown) in the walls 106 that facilitate movement of a substrate 140 into and out of the processing chamber 102. In one embodiment, the walls 106 and bottom 108 may be fabricated from a unitary block of aluminum or other material compatible with processing. In another embodiment, the walls 106 and bottom 108 may comprise separate pieces coupled together. The walls 106 support a lid assembly/backing plate 110. The processing chamber 102 may be evacuated by a vacuum pump 184.

A temperature controlled substrate support assembly 138 may be centrally disposed within the processing chamber 102. The support assembly 138 may support a substrate 140 during processing. The support assembly 138 may have a susceptor 134. The susceptor 134 supports the substrate 140 during processing. The susceptor 134 may have one or more heat exchange elements 132 embedded therein to provide a measure of control over the substrate temperature. A stem 142 may be coupled to the lower side of the support assembly 138. The stem 142 couples the support assembly 138 to a lift system (not shown) that moves the support assembly 138 between an elevated processing position and a lowered position that facilitates substrate transfer to and from the processing chamber 102. The stem 142 additionally provides a conduit for electrical and thermocouple leads between the support assembly 138 and other components of the apparatus 100.

A bellows 146 may be coupled between support assembly 138 or the stem 142 and the bottom 108 of the processing chamber 102. The bellows 146 provides a vacuum seal between the chamber volume 112 and the atmosphere outside the processing chamber 102 while facilitating vertical movement of the support assembly 138.

The support assembly 138 may be grounded such that RF power supplied by a power source 122 to a gas distribution plate 118 positioned between the lid assembly/backing plate 110 and substrate support assembly 138 (or other electrode positioned within or near the lid assembly/backing plate 110 of the chamber 102) may excite gases present in the process volume 112 between the support assembly 138 and the gas distribution plate 118. The RF power from the power source 122 may be selected commensurate with the size of the substrate to drive the PECVD process. Periodically, the chamber 102 may need to be cleaned. A cleaning gas may be supplied from a cleaning source 182. The cleaning gas may be remotely ignited into a plasma.

The processing gas and the cleaning gas may be provided to the chamber 102 through the lid assembly/backing plate 110 and enter a plenum 164 between the lid assembly/backing plate 110 and the gas distribution plate 118. The gas distribution plate 118 may be electrically coupled to the lid assembly/backing plate 110 by a bracket 160. The processing gas may pass from the plenum 164 to the processing area 112 through gas passages 162 formed through the gas distribution plate 118.

The support assembly 138 may additionally support a circumscribing shadow frame 148. The shadow frame 148 may prevent deposition at the edge of the substrate 140 and support assembly 138 so that the substrate 140 may not stick to the support assembly 138.

As shown in FIG. 1, a controller 186 may interface with and control various components of the substrate processing system. The controller 186 may include a central processing unit (CPU) 190, support circuits 192 and a memory 188.

The processing gas may enter into the chamber 102 from the gas source 104 and be exhausted out of the chamber 102 by a vacuum pump 184. As will be discussed below, when the substrate 140 is placed on the susceptor 134, the susceptor 134 raises to meet the shadow frame 148 such that the shadow frame 148 is resting on the susceptor 134 and placed around the substrate 140 to cover the area on the susceptor 134 that is exposed to the processing gas in the processing chamber 102. The shadow frame 148 is raised by the susceptor 134. To ensure the shadow frame 148 is properly aligned onto the susceptor 134, alignment inserts may be used. By placing the shadow frame 148 around the substrate 140, the deposition at the edge of the substrate 140 and the susceptor 134 may be reduced.

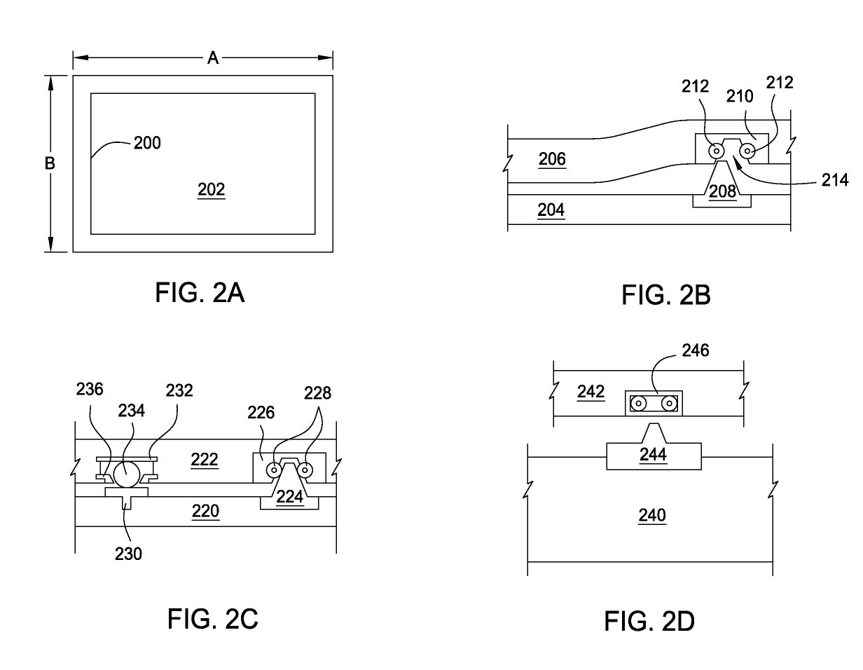

FIG. 2A is a schematic top view of a shadow frame 200. The shadow frame 200 has a substantially rectangular shape with an opening 202 therethrough where a substrate will be visible during processing. The shadow frame 200 may have a side having a length shown by arrows “A” and a width shown by arrows “B”. In one embodiment, the length and the width may each be greater than about 1 meter. Thus, both the length and the width may span a substantially large distance.

FIG. 2B is a schematic cross sectional view of a misaligned shadow frame 206. The susceptor 204 has one or more alignment pins 208 extending upward from the susceptor 204. The shadow frame 206 has a corresponding alignment receiver 210 having a cavity 214 which receives the alignment pin 208. One or more rollers 212 may be present within the alignment receiver 210. The one or more rollers 212 permit the alignment pin 208, which has a sloped outer surface, to slide thereon such that the alignment pin 208 substantially centers into the cavity 214. As shown in FIG. 2A, the shadow frame 206 bows even through the alignment pin 208 is in the cavity 214. Because the shadow frame 206 spans such a larger distance, the weight of the shadow frame 206 may be sufficient to cause the shadow frame 206 to bow rather than slide the alignment pin 208 along the rollers 212 to properly align the shadow frame 206.

FIG. 2C is a schematic cross sectional view of a shadow frame 222 aligned with an alignment assembly according to one embodiment. The susceptor 220 may have an alignment pin 224 extending therefrom. The shadow frame 222 may have an alignment receiver 226 having one or more rollers 228 therein that permit the alignment pin 224 to slide in the alignment receiver 226. As noted above, the shadow frame 222 may be quite large and thus, quite heavy. To prevent the shadow frame 222 from bowing and remaining misaligned, an additional alignment mechanism may be present.

The additional alignment mechanism may comprise a slider surface 230. The slider surface 230 may be recessed into or extending slightly above the susceptor 220. The shadow frame 222 may have a ball bearing 234 that is centered by a centering ring 236 and rolls along a bearing plate 232. The ball bearing 234 rolls along the slider surface 230 and the bearing plate 232. In so doing, the shadow frame 222 may be less likely to bow. Additionally, the alignment pin 224 therefore does not get stuck and the shadow frame 222 does not bow. Along each side of the shadow frame 222, one or more alignment receivers 226 and one or more ball bearings 234 may be present. In one embodiment, the one or more alignment receivers 226 and the one or more ball bearings 234 may be substantially centered along a side of the shadow frame 222.

FIG. 2D is a schematic cross sectional view of an alignment pin assembly according to one embodiment. The alignment pin 244 is shown embedded into and extending from the susceptor 240. The alignment receiver 246 is shown embedded into the shadow frame 242. It is to be understood that the alignment receiver 246 may be embedded in the susceptor 240 and the alignment pin 244 may be embedded in and extend from the shadow frame 242.

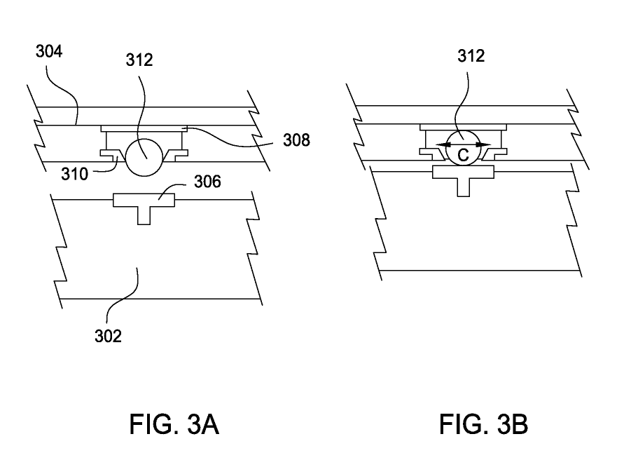

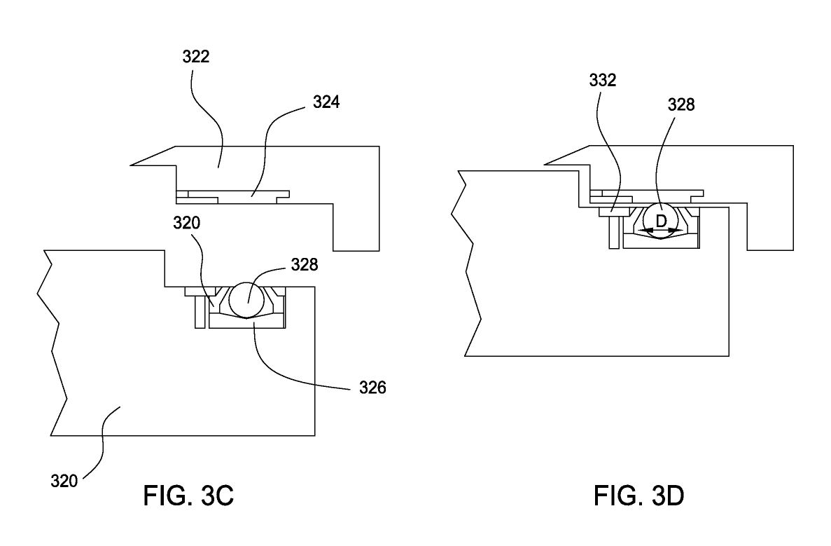

FIG. 3A is a schematic cross sectional view of an alignment ball assembly in a raised position according to one embodiment. FIG. 3B is a schematic cross sectional view of the alignment ball assembly of FIG. 3A in a lowered position. As shown in FIG. 3A, the susceptor 302 has the support button 306 embedded therein. In one embodiment, the susceptor 302 may comprise aluminum. In one embodiment, the support button 306 may comprise ceramic. In another embodiment, the support button 306 may comprise a dielectric material. In another embodiment, the support button 306 may comprise a low friction material. The support button 306 may comprise a dielectric material to ensure electrical isolation of the shadow frame 304 from the susceptor 302. In the embodiment shown in FIGS. 3A and 3B, the support button 306 is embedded within the susceptor 302 and partially extends above the surface of the susceptor 302. In one embodiment, the support button 306 may be substantially flush with the susceptor 302 such that the support button 306 has a top surface that is substantially planar with the top surface of the susceptor 302. The support button 306 is the surface upon which the ball 312 may roll to permit the shadow frame 312 to properly align.

The shadow frame 312 may have a ball assembly therein. The ball assembly may comprise a bearing plate 308, a ball 312, and a centering ring 310. In one embodiment, the bearing plate 308 may comprise ceramic. In another embodiment, the bearing plate 308 may comprise a dielectric material. In another embodiment, the bearing plate 308 may comprise a low friction material. The bearing plate 308 is the surface upon which the ball 308 may roll (in addition to the support button 306) to bring the shadow frame 304 into alignment. In the embodiment shown in FIGS. 3A and 3B, the bearing plate 308 may have a substantially planar surface upon which the ball 312 may roll to align the shadow frame 304.

The ball 312 may be contained within the assembly by a centering ring 310. In one embodiment, the ball 312 may comprise aluminum. In another embodiment, the ball 312 may comprise ceramic. In another embodiment, the ball 312 may comprise a metal. In another embodiment, the ball 312 may comprise a dielectric. In one embodiment, the centering ring 310 may comprise a dielectric. In another embodiment, the centering ring 310 may comprise a ceramic. In another embodiment, the centering ring 310 may comprise a low friction material.

The centering ring 310 permits the ball 312 to rest in the centering ring 310 when the shadow frame 312 is in the raised position shown in FIG. 3A. When the shadow frame 304 is coupled to the susceptor 302 as shown in FIG. 3B, the ball 312 is free to move in any direction as shown by the arrows “C” along the bearing plate 308 subject to the boundaries of the centering ring 310. The ball 312 is free to move to permit the shadow frame 304 to move relative to the susceptor 302 and properly align on the susceptor 302.

FIG. 3C is a schematic cross sectional view of an alignment ball assembly embedded according to another embodiment. FIG. 3D is a schematic cross sectional view of the alignment ball assembly of FIG. 3C in an aligned position. As shown by FIGS. 3C and 3D, the ball 328 may be in the susceptor 320 as opposed to the shadow frame 322. The shadow frame 322 may have a bearing plate 324 embedded therein to permit the ball 328 to slide thereon and properly align the shadow frame 322 on the susceptor 320. In one embodiment, the bearing plate 324 may comprise a dielectric material. In another embodiment, the bearing plate 324 may comprise a ceramic. In another embodiment, the bearing plate 324 may comprise a low friction material. In one embodiment, the bearing plate 324 may have a surface upon which the ball 328 rolls that is substantially coplanar with the shadow frame 322 bottom surface. In another embodiment, the surface of the bearing plate 324 upon which the ball rolls 328 may extend from the shadow frame 322 bottom surface.

The ball assembly, on the other hand, may be embedded within the susceptor 320. The ball assembly may comprise a ball 328, a support button 326, and a retaining ring 320. In one embodiment, the ball 328 may comprise a metal. In another embodiment, the ball 328 may comprise aluminum. In another embodiment, the ball 328 may comprise a dielectric. In another embodiment the ball 328 may comprise a ceramic.

The ball 328 may rest on a support button 326. In one embodiment, the support button 326 may comprise a dielectric. In another embodiment, the support button 326 may comprise a ceramic. The ball 328 rolls along the support button 326 when aligning the shadow frame 322. The support button 326 may have a slightly conical surface upon which the ball 328 rolls to permit the ball 328 to center on the support button 326. The ball 328 is permitted to roll in any direction as shown by arrows “D”.

A retaining ring 330 maintains the ball 328 within the ball assembly. In one embodiment, the retaining ring 330 may comprise a dielectric. In another embodiment, the retaining ring 330 may comprise a ceramic. The retaining ring 330 and hence, the ball assembly, may be coupled with the susceptor 320 by a fastening mechanism 332. In one embodiment, the fastening mechanism 332 may comprise a retaining screw that is received by threaded portions of the susceptor 320. The support button 326 may be placed in a cavity formed in the susceptor 320. The ball 328 may be placed on the support button. The retaining ring 330 may then be placed in the cavity formed in the susceptor 320 and in contact with the support button 326. The fastening mechanism 332 may then be coupled with the susceptor 320 to maintain the ball assembly within the cavity in the susceptor 320.

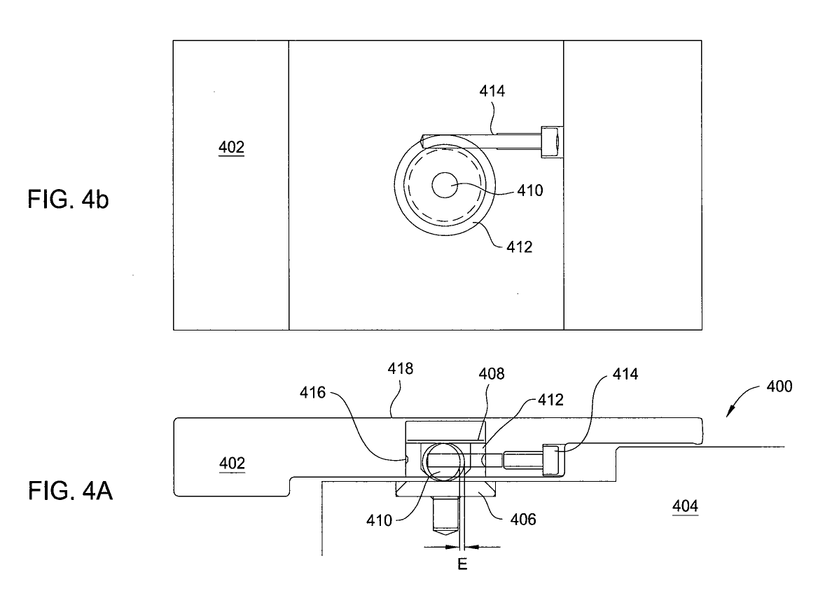

FIG. 4A is a schematic cross sectional view of an apparatus 400 according to one embodiment. FIG. 4B is a schematic bottom view of the shadow frame 402 of FIG. 4A. The shadow frame 402 is disposed above the susceptor 404. The susceptor 404, during processing, raises to meet the shadow frame 402 and raises the shadow frame 402 along with the susceptor 404. The susceptor 404 has a support button 406 embedded therein. The support button 406 is used to permit the shadow frame 402 to slide into alignment on the susceptor 404. In one embodiment, the support button 406 may comprise a ceramic material. In another embodiment, the support button 406 may comprise a low friction material.

The shadow frame 402, meanwhile, has a ball bearing 410 within that rolls on the support button 406 to align the shadow frame 402. In one embodiment, the ball bearing 410 may comprise a metal. In another embodiment, the ball bearing 410 may comprise aluminum. In another embodiment, the ball bearing 410 may comprise a ceramic material.

The ball bearing 410 may be retained within the shadow frame 402 by a retaining structure 412. In one embodiment, the retaining structure 412 may comprise a ceramic material. The ball bearing 410 may roll within the shadow frame on a bearing plate 408. In one embodiment, the bearing plate 408 may comprise a ceramic material. The ball bearing 410 is permitted to move within the area enclosed by the bearing plate 408 and the retaining structure 412 for a distance shown by arrows “E”.

The retaining structure 412 may have a groove 416 along the outside surface thereof to permit a fastening mechanism 414 to couple the retaining structure 412 to the shadow frame 402. In one embodiment, the fastening mechanism 414 may comprise a screw. While a groove 416 has been shown with the fastening mechanism 414 pressed thereagainst, it is to be understood that the fastening mechanism 414 may be coupled into the retaining structure 412 directly as opposed to pressed thereagainst. In such a situation, the retaining structure 412 may have threaded openings to receive the fastening mechanism 414. The bearing plate 408, ball bearing 410, retaining structure 412, and fastening mechanism 414 are all below the top surface 418 of the shadow frame 402 such that the top surface 418 is substantially planar and unitary in material.

It is to be understood that while the ball bearing 410 and the support button 406 have been shown in the shadow frame 402 and susceptor 404 respectively, the positions may be reversed.

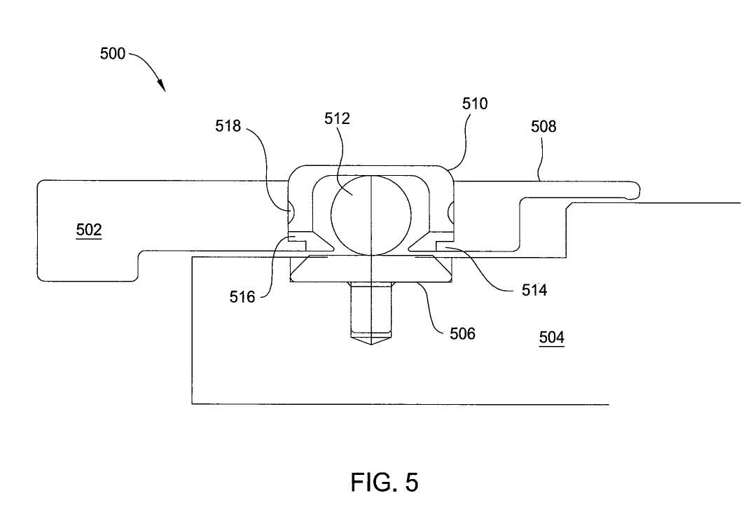

FIG. 5 is a schematic cross sectional view of an apparatus 500 according to another embodiment. The shadow frame 502 is disposed above the susceptor 504. The susceptor 504, during processing, raises to meet the shadow frame 502 and raises the shadow frame 502 along with the susceptor 504. The susceptor 504 has a support button 506 embedded therein. The support button 506 is used to permit the shadow frame 502 to slide into alignment on the susceptor 504. In one embodiment, the support button 506 may comprise a ceramic material. In another embodiment, the support button 506 may comprise a low friction material.

The shadow frame 502, meanwhile, has a ball bearing 512 within that rolls on the support button 506 to align the shadow frame 502. In one embodiment, the ball bearing 512 may comprise a metal. In another embodiment, the ball bearing 512 may comprise aluminum. In another embodiment, the ball bearing 512 may comprise a ceramic material.

The ball bearing 512 may be retained within the shadow frame 502 by an enclosure 510 and a retaining ring 516. In one embodiment, the enclosure 510 and retaining ring 516 may comprise a ceramic material. The retaining ring 516 may rest on a ledge 514 carved into the shadow frame 502. The retaining ring 516, ball bearing 512, and enclosure 510 may be inserted into the shadow frame 502 from the top surface 508 thereof.

The enclosure 510 may have a groove 518 along the outside surface thereof to permit a fastening mechanism to couple the enclosure 510 to the shadow frame 502. In one embodiment, the fastening mechanism may comprise a screw. It is to be understood that while the ball bearing 510 and the support button 506 have been shown in the shadow frame 502 and susceptor 504 respectively, the positions may be reversed.

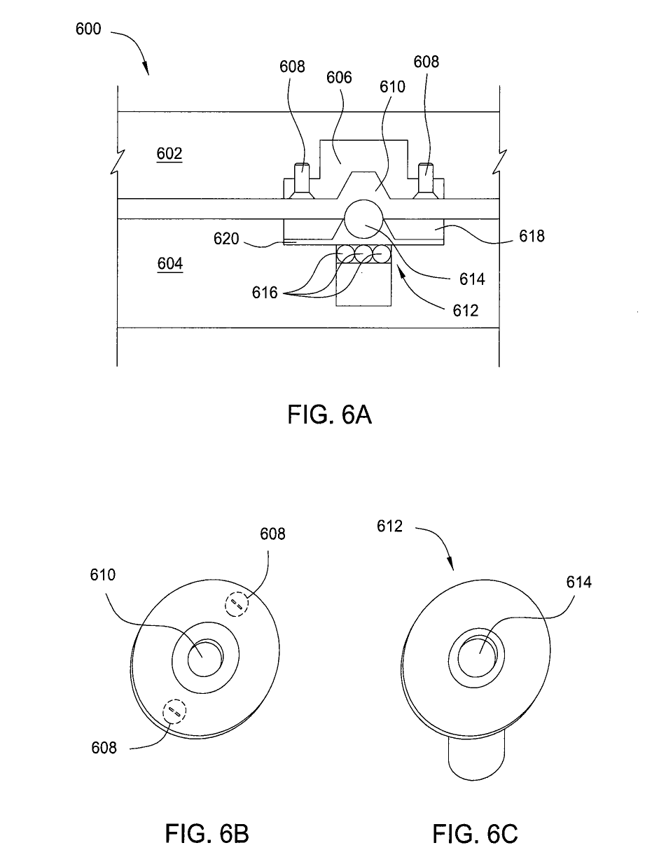

FIG. 6A is a schematic cross sectional view of an alignment assembly 600 according to another embodiment. The assembly includes a shadow frame 602 aligned on a susceptor 604. An alignment element 606 may be coupled to the shadow frame 602 by one or more fastening mechanisms 608. In one embodiment, the fastening mechanism 608 may comprise a screw. In one embodiment, the screw may comprise aluminum. In another embodiment, the screw may comprise anodized aluminum. In one embodiment, the alignment element 606 may comprise a ceramic material. The alignment element 606 may have a cavity 610 therein to receive an alignment ball 614 that is coupled to the susceptor 604.

An alignment button 612 may be coupled to the susceptor 604. The alignment button may have one or more balls 614 that engage the cavity 610 of the alignment element 606. In one embodiment, the ball 614 may comprise aluminum. In another embodiment, the ball 614 may comprise anodized aluminum. The ball 614 may roll within the button 612 on one or more smaller balls 616. In one embodiment, the balls 616 may comprise aluminum. In another embodiment, the balls 616 may comprise anodized aluminum. As can be seen in FIG. 6A, the ball 614 may have a larger diameter than the balls 616. The ball 614 is contained in the button 612 by a cover 618 that is coupled to a lower portion 620. FIG. 6B is an isometric view of the alignment receiver of FIG. 6A. FIG. 6C is an isometric view of the alignment button of FIG. 6A.

To alignment the shadow frame 602 on the susceptor 604, the susceptor 604 is raised and the ball 614 engages the sloped surface of the cavity 610. The sloped surface of the cavity 610 slides down the ball 614 and thus, the shadow frame 602 is aligned on the susceptor 604. As the sloped surface of the cavity 610 slides down the ball 614, the ball 614 rotates within the button 612 along the smaller balls 616. The smaller balls 616 rest on a low friction bearing surface. In one embodiment, the cover 618 and lower portion 620 each comprise a ceramic material.

It is to be understood that while the button 612 is shown coupled to the susceptor 604 and the alignment element 606 is coupled with the shadow frame 602, the items could be reverses such that the alignment element 606 is coupled with the susceptor 604 and the button 612 is coupled with the shadow frame 602.

By utilizing a ball assembly that has a ball capable of rolling on a bearing surface, a shadow frame may be properly aligned on a susceptor. If necessary, an alignment pin assembly may be used in addition to the ball assembly. The pin assembly in combination with the ball assembly may permit the shadow frame to roll into properly alignment over the susceptor when the susceptor raises the shadow frame into the processing position.

While the foregoing is directed to embodiments of the present invention, other and further embodiments of the invention may be devised without departing from the basic scope thereof, and the scope thereof is determined by the claims that follow.

1. A shadow frame, comprising:
a shadow frame body; and
one or more shadow frame slider assemblies recessed into the shadow frame body.

2. The shadow frame of claim 1, wherein the one or more shadow frame slider assemblies comprises:
a ball disposed within a first recess of the shadow frame body; and
a containment element coupled with the shadow frame body and movably containing the ball within the first recess.

3. The shadow frame of claim 2, wherein the ball comprises a ceramic material.

4. The shadow frame of claim 3, wherein the containment element comprises a ceramic material.

5. The shadow frame of claim 4, wherein the one or more shadow frame slider assemblies further comprises a bearing plate disposed within the first recess.

6. The shadow frame of claim 5, wherein the bearing plate comprises a ceramic material.

7. An apparatus, comprising:
a processing chamber body;
a susceptor disposed in the processing chamber body and having a surface for receiving a substrate, the susceptor movable from a first position to a second position;
one or more slider elements coupled to the susceptor;
a shadow frame disposed in the processing chamber body, the shadow frame movable from a third position spaced from the susceptor to a fourth position in contact with the susceptor; and
one or more shadow frame slider assemblies coupled to the shadow frame.

8. The apparatus of claim 7, wherein the one or more shadow frame slider assemblies comprises:
a ball disposed within a first recess of the shadow frame; and
a containment element coupled with the shadow frame and movably containing the ball within the first recess.

9. The apparatus of claim 8, wherein the ball comprises a ceramic material.

10. The apparatus of claim 9, wherein the containment element comprises a ceramic material.

11. The apparatus of claim 10, wherein the one or more shadow frame slider assemblies further comprises a bearing plate disposed within the first recess.

12. The apparatus of claim 11, wherein the bearing plate comprises a ceramic material.

13. The apparatus of claim 12, wherein the apparatus is a plasma enhanced chemical vapor deposition apparatus.

14. The apparatus of claim 7, wherein the apparatus is a plasma enhanced chemical vapor deposition apparatus.

15. A method of aligning a shadow frame above a susceptor, comprising:
moving a susceptor from a first position to a second position, the susceptor having one or more slider surfaces;
moving a shadow frame from a third position spaced from the susceptor and a fourth position in contact with the susceptor when the susceptor is in the second position, the shadow frame having one or more shadow frame slider assemblies coupled thereto; and
sliding the one or more shadow frame slider assemblies along the one or more slider surfaces to align the shadow frame above the susceptor.

16. The method of claim 15, wherein the sliding comprises moving a ball along the slider surface, wherein the ball is disposed within a first recess of the shadow frame and wherein a containment element is coupled with the shadow frame and movably contains the ball within the first recess.

17. The method of claim 16, wherein the ball comprises a ceramic material.

18. The method of claim 17, wherein the containment element comprises a ceramic material.

19. The method of claim 18, further comprising rolling the ball along a bearing plate disposed within the first recess.

20. The apparatus of claim 19, wherein the bearing plate comprises a ceramic material.
